(19) United States
(12) Patent Application Publication
(10) Pub. No.: US 2004/0234068 A1
(43) Pub. Date: Nov. 25, 2004

(54) Volume control in a communication device interface unit

(76) Inventors: Niels Christian Steen Hansen, Solrod Strand (DK); Ole N Christensen, Solrod Strand (DK)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/481,325

(22) PCT Filed: Jun. 28, 2002
(86) PCT No.: PCT/DK02/00453

(30) Foreign Application Priority Data
Jun. 28, 2001 (PA) 2001-01048

(51) Int. Cl. H04M 1/00; H04M 9/00

(52) U.S. Cl. 379/388.03; 379/388.06

(57) ABSTRACT

A method for controlling the volume in a communication device interface unit connected to a communication device base station, where the interface unit includes a signal path for a speaker containing unit, where the input level is adjusted by a volume control and where the output is controlled simultaneously the same volume control. Also disclosed in a communication device interface unit including a first signal path for a speaker-containing unit, where the interface unit includes a volume control for manually controlling output volume, where the interface unit includes a first control circuit for controlling the level of the input to the interface unit and a second control circuit for controlling the output from the interface unit, and where the first and the second control circuits are controlled by the same volume control.

### AREA OF THE INVENTION

The invention relates to the area of communication device interface units, and more particularly to the area of interface units where the volume in a communication device interface unit has to be set to a specific users need.

### BACKGROUND OF THE INVENTION

When using such devices it is necessary to adjust the interface unit to the communication device in order to obtain the desired level of output and input. This is normally done manually by adjusting suitable potentiometers. As the adjustment requires some technical know-how it can be a challenge for many people. A desire for an automatic or semi automatic adjustment (self-configuring) of such devices therefore exists.

A adjustment of the levels is often necessary for the users comfort. In known devices this is normally done by setting a gain control to a specific maximum value, which defines the amplification for all frequencies at all input levels. This previously known method of adjusting the gain does not provide for comfort in the situation of use and the amplification of signal at in practice all input levels means that noise generated by components in the system will also be amplified and give rise to discomfort.

One example of such self-configuring communication device interface units is disclosed in U.S. Pat. No. 5,729,603. This previously known device deals with the general principles of recognizing the microphone containing unit and the successive measuring of the relevant output values in order to determine a setting of an amplifier. The subsequent volume control performed by the user is not dealt with in this publication.

When using Automatic Gain Control (AGC) in a headset amplifier the AGC level is normally set to 0 dB. If the input level is below 0 dB the amplifier will increase the signal level to 0 dB output level. If the input level is above 0 dB the amplifier will lower the signal level to 0 dB.

When the regulation is alone applied on the input signal, the level set in the AGC is at the same time the maximum output level.

When the regulation is alone applied on the output signal, a maximum non-attenuated signal is always applied to the amplifier. This signal is afterwards amplified by the AGC amplifier base amplification and is maintained at 0 dB. This means that the noise during non-speech periods will be amplified significantly.

The objective of the present invention is to provide a method and a device, which to a significant degree eliminates this disadvantage and thereby allows the user of the speaker containing unit to adjust the gain in a manner that to the best possible extend provides listening comfort to the user.

### SUMMARY OF THE INVENTION

According to the invention this is achieved by means of a method as defined in claim 1.

By controlling the volume in the manner defined the user will be able to obtain a significantly more comfortable volume setting. This is primarily due to the fact that noise, e.g. generated by the device itself, which may have a low input voltage, is not amplified to a uncomfortable level, as only signal having higher input level will be amplified to the maximum level. By the combined regulation the advantages of both the input regulation and the output regulation have been obtained. This means that noise signals are not amplified during uncomfortably during non-speech periods and that at the same time a low level speech input signal will reach a satisfactory output level.

A preferred embodiment is defined in claim 2. The attenuation will provide increased comfort for the user as noise signals present in pauses will be eliminated.

A further preferred embodiment is defined in claim 3. The clipping will provide an increased safety of the system as the output level will not rise beyond a certain predetermined level. Shock damages of the user ears can hereby be avoided.

According to the invention the objective is further achieved by means of an interface unit as defined in claim 4.

A preferred embodiment is depicted in claim 5. The AGC will provide a comfortable control of the signal level without disturbing this as the signal information is maintained in a compressed form.

A further preferred embodiment is defined in claim 6. The attenuation will provide increased comfort for the user as noise signals present in pauses will be eliminated.

A still further preferred embodiment is defined in claim 7. The clipping will provide an increased safety of the system as the output level will not rise beyond a certain predetermined level. Shock damages of the user ears can hereby be avoided.

The invention is described more detailed in the following description of a preferred embodiment, with reference to the drawings.

### BRIEF DESCRIPTION OF THE DRAWINGS

FIG. 1 is a schematic diagram showing the communication device base station and the speaker-containing unit.

FIG. 2 is a schematic diagram showing the volume control circuitry.

FIG. 3 shows the input-output relations for different volume settings.

### DESCRIPTION OF A PREFERRED EMBODIMENT

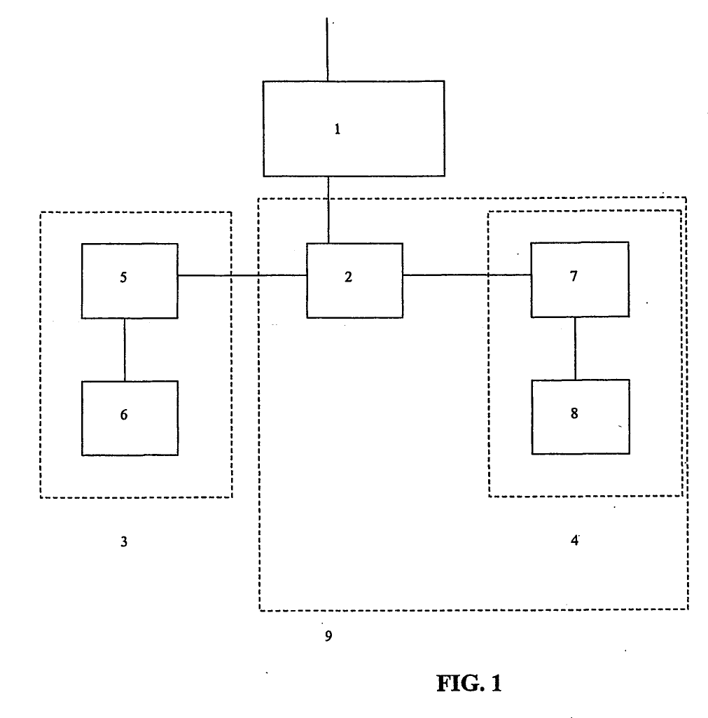

From FIG. 1 a system appears including the unit according to the invention and a telephone device. The telephone device is connected to the telephone network, wired or wireless. The telephone unit normally comprises a base station and a handset connected to the base station via an input/output port. The input/output port is used for connection of the interface unit. The interface unit comprises an input/output port for the handset and for an additional device, which could be a headset or a conference microphone. The handset and the base station will normally be adapted to each other for optimal use, i.e. the gain is adapted to the impedance of the handset. The additional device will as a general device not be adapted for a specific telephone and will therefore need adjustment in relation to the telephone with which it is intended to be used. The interface unit and the microphone-containing device can be a single integrated unit.

Having adapted the interface device to the telephone base unit, the device and headset is in principle ready for operation. There may however still exist a need for individual volume setting and for this purpose the device comprises a volume control for manual adjustment of the output volume.

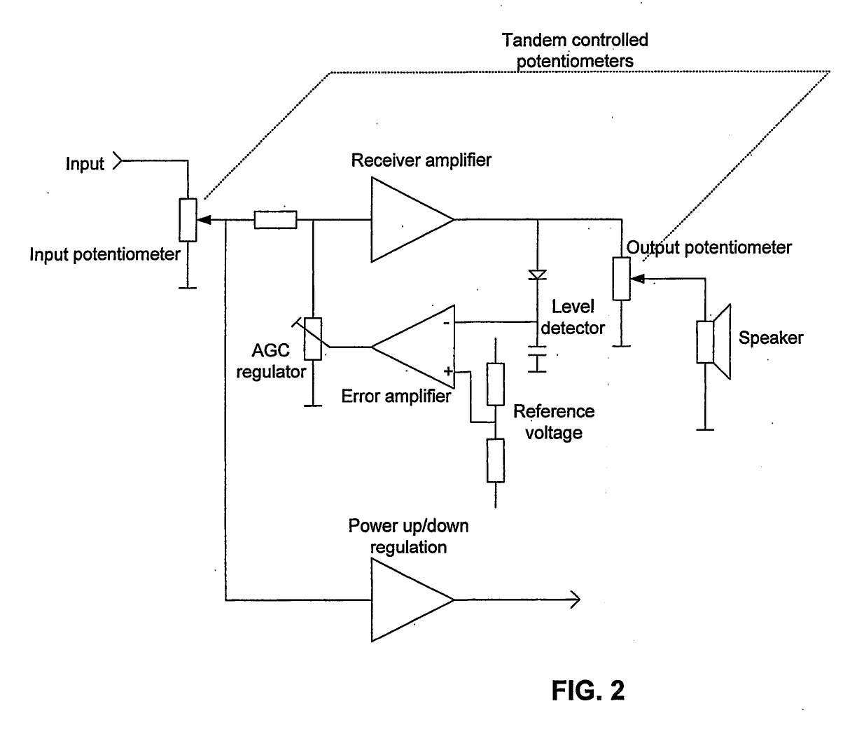

This volume control has been implemented in a manner where a maximum output level is set and where at the same time the input/output relation or ratio is adjusted. The practical implementation of this is indicated in the diagram shown in FIG. 2. Here circuit comprises two volume or gain control circuits, so-called Automatic Gain Control (AGC) circuits. The first AGC circuit controls the input signal level and the second AGC circuit controls the output signal level. Having the combination of these two AGC's will provide the desired functionality as described above.

The AGC circuit comprises a level detector and a regulation means. These components constitute a compressor with a given compression capability. When a level is detected above a predetermined level the regulator of the AGC will regulate the gain or volume according to the specifications of the particular compressor.

The circuit further comprises a peak-clipping means for clipping the output when a certain predetermined upper level for the output is reached. This feature improves the safety of the device in situations where the input level is very high and cannot be attenuated by the AGC/compressor circuit and/or where the AGC attack time will not be sufficiently fast to make the AGC/compressor circuit attenuate the signal.

Furthermore an attenuation circuit is provided, which provides a significant attenuation of the output signal when the input signal goes below a certain predetermined lower input level. This feature improves the comfort as noise signals, which are typically audible when there is no speech, will be attenuated to a level where these are not disturbing. An alternative solution could be a total shut off of the system.

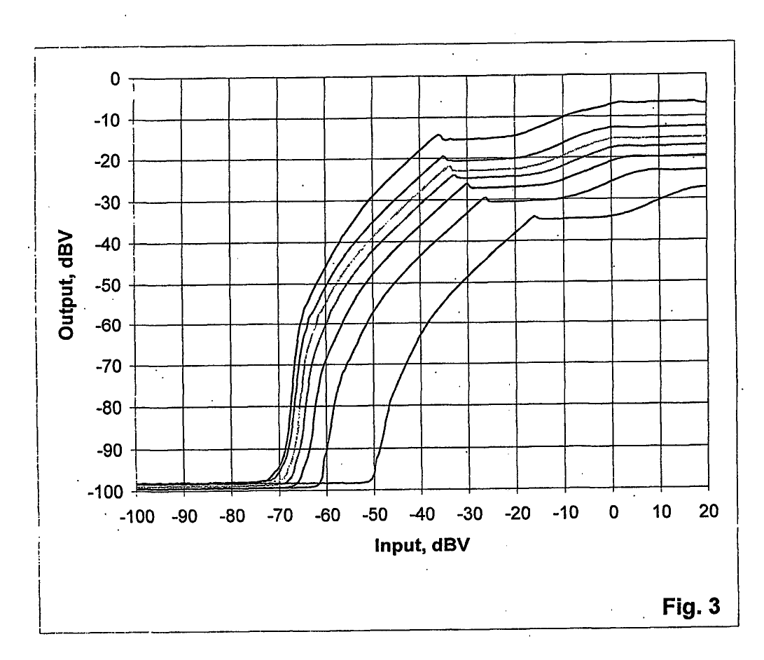

The input-output relation is indicated in FIG. 3. It becomes apparent that for a specific maximum output volume setting, the input-output relation, until a certain knee-point value of the input has been reached, the output will be determined by a related input-output relation. Above this input level the maximum output will apply for all input values. For a different setting of the maximum value output volume, a different input-output relation will apply, i.e. for a lower maximum output setting the relation will decrease (indicated by a less steep curve) and for a higher maximum output setting the relation will increase (indicated by a steeper curve). At a low input level the output is significantly attenuated and at very high input levels the output level is limited by peak clipping. This provides comfort and safety.

1-8. (Cancel)

9. A method for controlling the volume in a communication device interface unit connected to a communication device base station, where the interface unit comprises a signal path for a speaker containing unit, where the input level is adjusted by a manually operated volume control and where the acoustic output level is controlled simultaneously by the same volume control, where the output is attenuated at signal input levels below a predefined level and where the output is clipped when a certain predefined upper output level is reached.

10. A communication device interface unit comprising, the interface unit comprises a first signal path for a speaker containing unit, where the interface unit comprises a manually operated volume control for manually controlling output volume, where the interface unit comprises a first control circuit for controlling the level of the input to the interface unit and a second control circuit for controlling the output from the interface unit, where the first and the second control circuits are controlled by the same manually operated volume control, where a switching means is provided for switching of the output signal when the input signal is detected to be below a predetermined lower input level, and where a peak-clipping means is provided for clipping the output signal when the output signal is detected to be above a predetermined upper output level.

11. A communication device interface unit according to claim 10, wherein said control circuit controlling the maximum output is an AGC circuit.

12. A communication device according to claim 10, including an attenuation means for attenuation of the output signal when the input signal is detected to be below a predetermined lower input level.
